(19) United States
(12) Patent Application Publication
(10) Pub. No.: US 2001/0051910 A1
(43) Pub. Date: Dec. 13, 2001

(54) System and method for conducting an auction over a communications network

(76) Inventors: William Martin Snelgrove, Toronto (CA); Michael Stumm, Toronto (CA); Mauricio De Simone, Toronto (CA)

Correspondence Address: PATENT ADMINSTRATOR, KATTEN MUCHIN ZAVIS, SUITE 1600, 525 WEST MONROE STREET, CHICAGO, IL, 60661, US

(21) Appl. No.: 09/809,421

(22) Filed: Mar. 16, 2001

Related U.S. Application Data
(63) Continuation of application No. PCT/CA99/00871, filed on Sep. 24, 1999.
(60) Provisional application No. 60/101,857, filed on Sep. 25, 1998.

(30) Foreign Application Priority Data
Mar. 4, 1999 (CA) 2,264,407

(51) Int. Cl. G06F 17/60

(52) U.S. Cl. 705/37; 705/26

(57) ABSTRACT

Methods of holding auctions over the Internet and telephone systems are known in the art but generally share the following problems: it is difficult for the auctioneer to identify bidders; telephone conferences are very noisy when they have a large number of participants; there is no method of ejecting a bidder who chooses to interfere with the auction; and it is difficult to enforce payment because it is difficult to verify the identity and creditworthiness of bidders. The invention provides for an auction system where bidders are identified using authentication or similar techniques, and their bids are filtered to reduce noise and eliminate unwanted bids or comments before being broadcast to the balance of the bidders. Other optional features are also described such as the recording and timestamping of bids.

### FIELD OF INVENTION

The present invention relates generally to communication networks and more particularly to a system for conducting an auction over a communications network.

### BACKGROUND

Traditional auctions take the form of a physical gathering of bidders at an auction place. A major limitation associated with physical auctions is that bidders are forced either to travel or to appoint a representative for the auction.

Advance bidding may be done by mail or by facsimile so that bidders do not have to be physically present at the auction. However, advance bidding suffers a significant disadvantage as compared to real-time bidding since it lacks immediacy and the bidders have no opportunity to increase a bid in quick response to competitive bids.

Several methods of conducting auctions over the Internet in real-time fashion are known. This requires, however, that all participants in the auction use an Internet-connected computer. Furthermore, auctioneers may find that it is more difficult to obtain a good price with an auction conducted over the Internet because it lacks the excitement that can be conveyed by voice.

Telephone conference systems are used today to share, in real-time, voice messages among persons in various locations. It is difficult, however, to hold an auction using a traditional telephone conferencing system, at least for the following reasons: the auctioneer may have difficulty identifying bidders by their voices; telephone conferences are very noisy when they have a large number of participants; there is no method of ejecting a bidder who chooses to interfere with the auction by making noise or pretending to be the auctioneer; and it is difficult to enforce payment because it is difficult to verify the identity and creditworthiness of bidders.

### SUMMARY OF INVENTION

It is therefore an object of this invention to provide an improved auction system that overcomes totally or in part the limitations of the above-mentioned auction systems.

One aspect of the invention is defined as a bidder message processor comprising processing means for processing a bidder message entered through a bidder voice terminal into a bidder data signal, wherein said bidder data signal includes a bidder identifier, and output means for outputting the bidder data signals at an auctioneer terminal.

Another aspect of the invention is defined as a bidder message processor system comprising a bidder message processor and connecting means. The bidder message processor comprises processing means for processing a bidder message entered through a bidder voice terminal into a bidder data signal, wherein said bidder data signal includes a bidder identifier, and output means for outputting the bidder data signals at an auctioneer terminal. The connecting means connect the bidder message processor to the bidder voice terminal over a communications network.

Another aspect of the invention is defined as an auctioneer message processor system comprising an auctioneer voice transmitter for broadcasting auctioneer voice messages from an auctioneer terminal simultaneously to a plurality of bidder voice terminals, and connecting means for connecting said bidder voice terminals to said auctioneer voice transmitter over a communications network.

A further aspect of the invention is defined as an auction system for use in an auction conducted over a communications network, the auction system comprising a bidder message processor, an auctioneer voice transmitter and connecting means.

The bidder message processor comprises means for processing a bidder message entered through any one of a plurality of bidder voice terminals into a bidder data signals, wherein said bidder data signal comprises a bidder identifier, and means for outputting the bidder data signals at an auctioneer terminal. The auctioneer voice transmitter broadcasts auctioneer voice messages from the auctioneer terminal simultaneously to selected bidder voice terminals. The connecting means connect said bidder voice terminals to the bidder message processor and to the auctioneer voice transmitter over the communications network.

A further aspect of the invention is defined as an auction system comprising auctioneer output means, a plurality of bid interpreters which in operation are connected to a plurality of corresponding bidders voice terminals, an auctioneer voice manager coupled to the bid interpreters, for receiving voice messages from an auctioneer voice transmitter over the communications network and for broadcasting the auctioneer voice messages simultaneously to all bidder voice terminals connected to the bidder interpreters. Each bid interpreter includes means for decoding bidder messages, means for attaching corresponding bidder identifiers to each decoded bidder message and forming data signals and means for transmitting the data signals to the auctioneer output means, over a communications network.

A further aspect of the invention is defined as a method of processing bidder messages for use in an auction conducted over a communications network, the method comprising the steps of processing a bidder messages received entered through a voice terminal into a data (digital) signals, the processing step comprising attaching a bidder identifier to said data signal, and outputting said data signal at an auctioneer terminal;

A further aspect of the invention is defined as a method of conducting an auction over a communications network, the method comprising the steps of transmitting bidders messages over the communications network and transmitting auctioneer messages over the communications network. The step of transmitting bidders messages comprises receiving the bidder messages from a plurality of bidder voice terminals, processing bidders messages into data signals, forming output signals by attaching bidder identifiers to selected data signals, and sending and outputting the output signals at an auctioneer terminal. The step of transmitting auctioneer messages comprises receiving the auctioneer messages from the auctioneer terminal and broadcasting the auctioneer messages to selected bidder voice terminals.

### BRIEF DESCRIPTION OF DRAWINGS

The present invention will be further understood from the following detailed description, with reference to the drawings in which:

FIG. 1 presents a block diagram of an auction system in accordance with an embodiment of the invention;

FIG. 2 presents a block diagram of a bidder message processor system in accordance with the embodiment in FIG. 1; and

FIG. 3 presents a block diagram of an auction system in accordance with a preferred embodiment of the invention.

### DETAILED DESCRIPTION OF PREFERRED EMBODIMENT

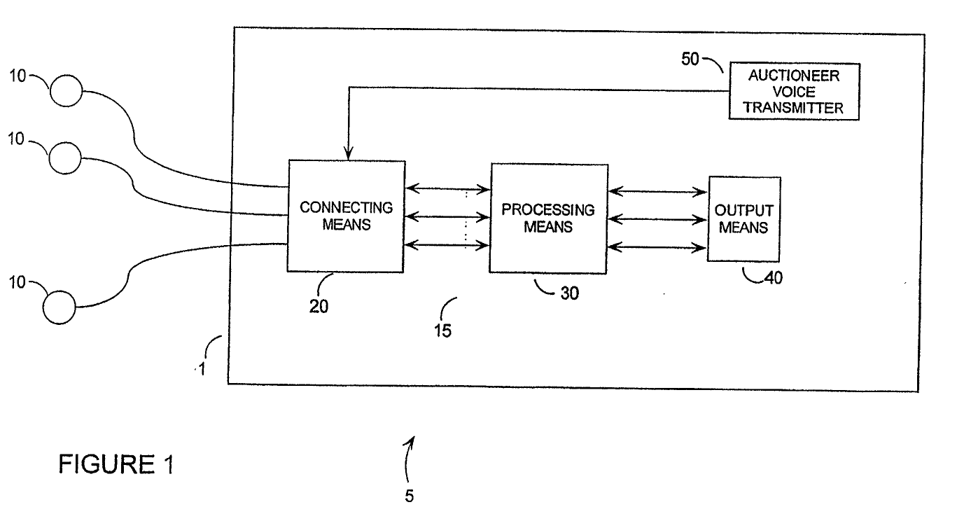

FIG. 1 presents a block diagram of an auction system 1 in accordance with an embodiment of the invention. Auction system 1 is used to facilitate the participation, in real-time, of persons located at various physical locations in an auction, by means of voice terminals 10. The communication takes place over a communications network 5, comprising the bidder voice terminals 10 and the auction system 1.

The auction system 1 comprises an auctioneer voice transmitter 50, a bidder messages processor 15 and connecting means 20 connecting the bidder voice terminals 10 to the auctioneer voice transmitter 50 and to the bidder messages processor 15. The bidder messages processor 15 comprises processing means 30 and output means 40.

The bidder voice terminals 10 may be any one of cordline, cordless, wireless telephone sets or the like. Other voice terminals may also be used, as they emerge.

The connections between various components of the auction system 1, as well as between the bidder voice terminals 10 and the auction system, can be physical connections, wireless connections or a combination of both. Likewise, it will be appreciated by a person skilled in the that the elements of the auction system 1, such as the connecting means 20 and the processing means 30, can each comprise sub-elements distributed at various physical locations. Furthermore, they may be mainly software structures attached to existing hardware platforms available in existing communications networks, specially designed hardware platforms, or a combination of both, such as interface access cards. Moreover, the auctioneer's tasks may be performed by a person or by a data processor that may act on location or remotely, in analyzing the information on the output means 40 and commanding the auctioneer voice transmitter 50 to send voice messages to bidder terminals 10. Therefore, the communication links and the blocks shown in the block diagram of FIG. 1 should not be considered restrictive in a physical sense.

In operation, a bidder participating in an auction conducted using the auction system 1 of FIG. 1, enters bidder messages through a bidder voice terminal 10. The bidder messages are transmitted to the processing means 30 through connecting means 20. The bidder messages are processed into bidder data signals to be outputted at the output means 40 in order of arrival. The processed bidder data signals comprise information on the bidder message content as well as a bidder identifier. Therefore, through the output means 40, the auctioneer acknowledges the content of bidder messages and the identity of bidders that originate the messages, in orderly fashion. This allows the auctioneer to identify the bidders, reducing ambiguity when more bids are received within a small time interval from various locations.

In order to communicate with the bidders, the auctioneer generates voice messages through the auctioneer voice transmitter 50. From the auctioneer voice transmitter 50, the auctioneer voice messages are broadcasted simultaneously to the bidder voice terminals 10 through the connecting means 20.

The connecting means 20 comprises input/output (I/O) ports which allow messages from the bidder voice terminals 10 to pass through to the rest of the auction system 1 and allow messages from the auction system 1 to be transmitted to the bidder voice terminals 10. The connecting means can be any combination of hardware and software connecting means available in existing communication networks, such as wire circuits, fiber optics circuits, wireless circuits, virtual connections, with or without associated controls, such as manually operated switchboards or other interfaces, or through embedded logical systems, comprising multiplexers, flip-flops, latches and the like. Since the connecting means 20 regulates the flow of messages from and to the bidder voice terminals 10, the connecting means 20 maintains a record of bidders participating in the auction, through the auction system 1. The record of participating bidders can be maintained in a list set-up for this purpose, or by simply maintaining the communication channels with participating bidders open, and ensuring that communication channels with non-participating bidders are blocked. Preferably, the record of bidders participating to the auction is updated based on access conditions. Such an embodiment will be described in more detail hereinafter.

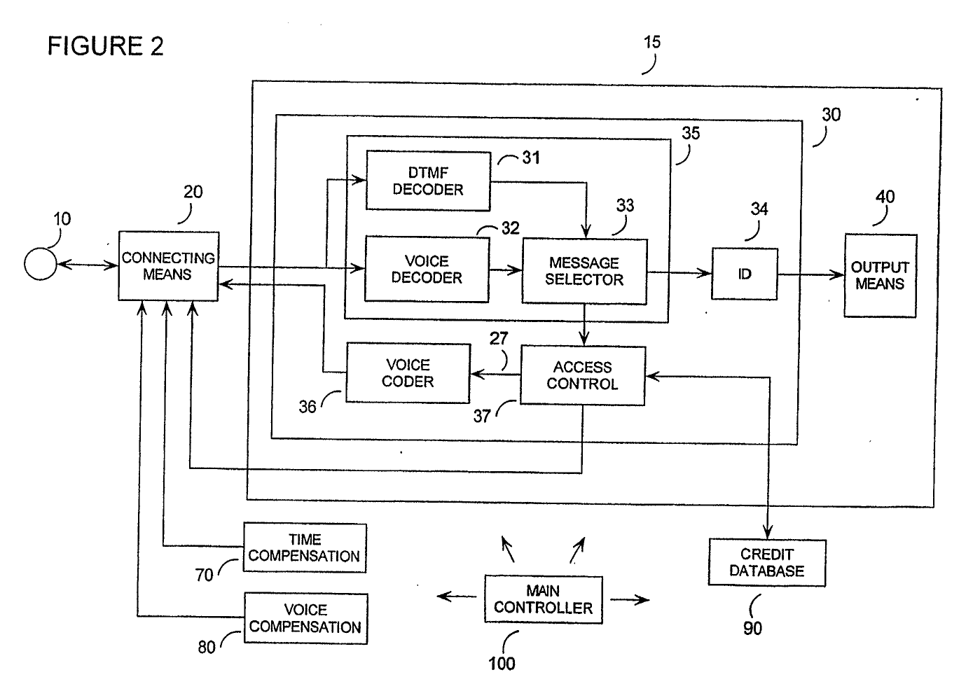

FIG. 2 presents a detailed view of the bidder message processor 15 and the connecting means 20, according to an embodiment of the invention.

The bidder message processor 15 comprises processing means 30 and output means 40.

In the embodiment in FIG. 2, the processing means 30 comprises recognizing means 35, a bidder identifier appending block 34, an access control block 37 and a voice coder 36.

A bidder message entering the processing means 30 is routed to the recognizing means 35, where its content is recognized. The recognizing means 35 select the auction relevant messages from other bidder messages that a bidder may input through a bidder voice terminal 10. The auction relevant messages can be, for example, bids or access messages.

The valid bids can be numerical voice messages such as “One hundred and fifty (150)”, or “Two thousand(2000)”. For simplicity, it is assumed that the price and the bids are represented by numerical values. However, it will be understood that an auction may be conducted by coding the implied trading means otherwise than in a numerical fashion, for example by a color code.

The access messages generally contain information which bidders are required to provide in order to participate in various stages of the auction. The access messages may be passwords, credit information, confirmations of compliance with terms and conditions of the auction, and the like.

Through the bidder voice terminals 10, bidder messages can be entered in various ways. The bidder messages may be voice messages or digital signals. For example, if a bidder voice terminal 10 is a telephone set having the touch-tone™ option, bidder messages can be entered as Dual-Tone-Multi-Frequency (DTMF) signals.

The embodiment depicted in FIG. 2 comprises a DTMF decoder 31 and a voice decoder 32, for decoding the bidder messages into data signals that are further filtered by a message selector 33. The DTMF decoder 31 and the voice decoder 32, may be any such decoders known in the art. Based on the decoded bidder messages coming from the DTMF decoder 31 or from the voice decoder 32, the message selector 33 selects the auction relevant bidder messages. The message selector 33 may comprise, for example, a database comprising codes representing either auction relevant messages or parts of auction messages, such that bidder messages can be selected as being relevant to the auction being conducted or as being unintelligible with respect to the auction conducted. However, any other means known in the art for identifying a given signal as matching one of a plurality of predetermined codes, can be employed for the implementation of the message selector 33. Voice recognition algorithms common in the art often comprise voice decoding means and selection means such as blocks 32 and 33 in FIG. 2.

Message selector 33 may perform one of several tasks. Some of the auction relevant messages, such as bids, are sent to the bidder identifier appending block 34 which appends a bidder identifier, and sends the message, in this new form, to the output means 40. Other auction relevant messages, such as access messages, may be analyzed within an access control block 37. Bidder messages selected as being unintelligible with respect to the conducted auction may be discarded or may be sent to the access control block 37, as well.

The access control block 37 may perform one or more of several functions. The access control block 37 may verify an access message such as a password or a credit card number, for example by accessing special databases such as a credit database 90. Also, in order to determine the access rights of a bidder to the auction, the access control block 37 may generate access information requests as data signals 22 that are coded into voice messages by a voice coder block 36 and sent, through the connecting means 20, to targeted bidder voice terminal 10. Furthermore, upon determining whether a certain bidder may or may not participate in the auction, the access control block 37 may send control signals 24 to the connecting means 20, instructing the connecting means 20 to allow or to restrict the communication of said bidder with the auction system 1. In this way, the access control block 37 updates the record of bidders participating in the auction, which is maintained by the connecting means 20 as previously described.

Whenever the message selector 33 detects a bidder message that is not relevant to the auction, which may be just noise or a comment not pertaining to the auction, the message selector can either discard such a message or it can allow the auction system 1 to respond to such a message, by sending an indicative signal to the access control block 37. Upon reception of such a signal, indicating the reception of a bidder message that is not relevant to the auction, the access control block 37 may generate an alert signal. Alert signals may be further processed in various ways. They may be stored within a memory component of the access control block 37 for further use. Also, an alert signal may be sent through the voice coder block 36 and through the connecting means 20, to the bidder voice terminal 10 at which said message selected as being not relevant to the auction originated. Such an alert signal may, for example, inform the bidder that the message was not understood and it must be re-entered, or, that the bidder voice terminal 10 has to be disconnected from the auction system 1, because of the unacceptable transmission of repeated unintelligible messages.

The output means 40 are preferably, but not restricted to, visual display means such as a monitor screen, that permit an auctioneer to acknowledge the bidder messages and the identity of the bidders originating them.

A time compensation block 70 allows the auction system 1 to estimate propagation delays of signals in traveling within the communications network 5. The estimates may be used to compensate for the bias in favor of physically closer bidders, for whom the bidding signals have to travel a smaller distance. In deciding which bid was placed first in real-time, to compensate for these delays, the computer may subtract the round trip delay through network 5 from the time at which the bid was received at the output means. The estimates may also be used to alert the auctioneer that a bidder had entered a bid before being able to hear the closing gavel, and that his bid should therefore be allowed.

The time compensation block 70 can obtain the propagation delay estimates by any suitable technique known in the art. For example, they can be obtained from the controlling software of the network 5. Alternatively, round-trip estimates may be obtained by estimating the delay before receiving an echo from the bidder voice terminal 10 using a system identification algorithm based on the echo cancellation technique known in the art. Another option is to attach a time stamp to every message originated within the auction system 1 or at a bidder voice terminal 10.

In the embodiment in FIG. 2, a voice conferencing block 80 is used to enable a voice conferencing system among the auctioneer and the participating bidders. The voice conferencing block 80 may use any of the common voice-conferencing techniques known in the art, preferably combined with techniques used to reduce the effect of combining background noise from many sources, such as the companding or squelch techniques.

In the embodiment depicted in FIG. 2, the time compensation block 70 and the voice conferencing block 80 are shown as being connected to the connecting means 20, since preferably, either one of the routines achieved by these blocks involves only bidders participating in the auction. As previously described, a record of such bidders is maintained through the connecting means 20.

A controller 100 controls the overall operation of the components of the auction system 1. For example, the controller 100 determines the output format on the output means 40 as well as various access control routines within the access control block 37. Preferably, the auctioneer may access the auction system 1 and determine the operation of its components through an auctioneer interface (not shown), linked to the controller 100.

The embodiment of the invention presented in FIGS. 1 and 2 addresses the problems noted in the Background section, as follows. The auction system in FIGS. 1 and 2 allows real-time communication among bidders and auctioneer, without requiring bidders to be physically present at an auction place, or to appoint a representative at an auction place. Through this system, bidders may communicate bidirectionally with the auctioneer by means of voice terminals. By allowing the auction to be conveyed by voice at least on the bidders side, the system described above is closer to recreating the atmosphere of physical auctions and thus can be found more entertaining or easier to use by potential bidders, leading to a potentially more competitive bidding process. Furthermore, voice terminals can be incorporated within personal computers or they can function as independent pieces of equipment. In the later case, they can be more accessible in terms of cost of use. Furthermore, current voice terminals are usually wider spread and better connected to existing communication networks, than Internet connected computers used in prior-art systems. Even further, wireless voice terminals are smaller and lighter, thus easier to carry than personal computers.

In addition, the auction system 1 presented in FIGS. 1 and 2 overcomes the problems that would be encountered in conducting an auction using a traditional telephone conference system, mentioned in the background. Incoming messages from bidders are processed in a form that allows the auctioneer to identify corresponding bidders, through the output means 40. Messages from bidders are outputted in order of arrival. Through the time compensation block 70, the auction system 1 may account for delays over the communications network 5. Through the access control block 37, bidders without credit or bidders that choose to interfere with the auction by making noise can be ejected from the auction.

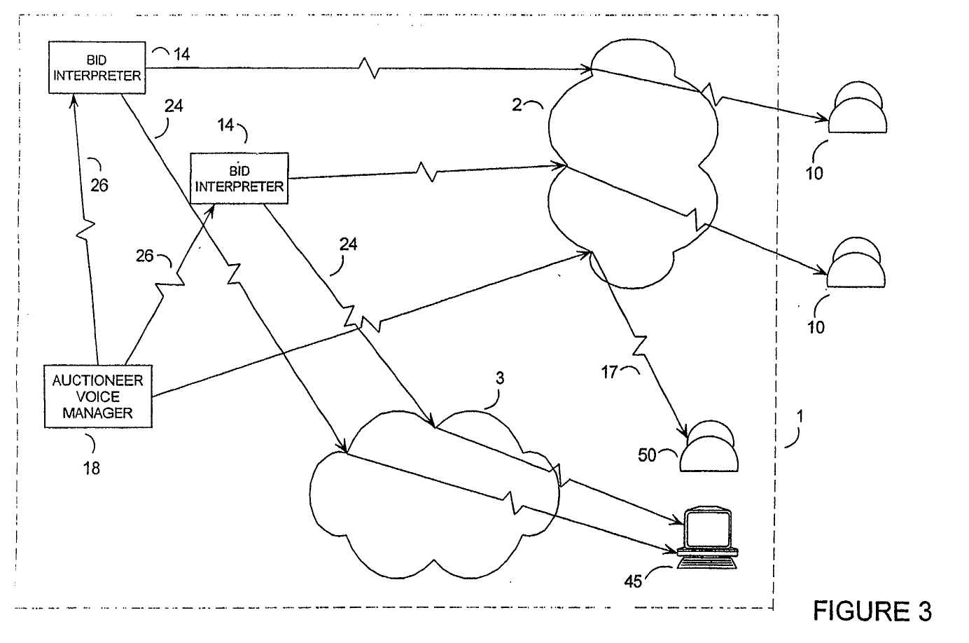

FIG. 3 shows a block diagram of an auction system 1 in accordance with a preferred embodiment of the invention. The auction system 1 comprises a plurality of bid interpreters 14, an auctioneer's computer 45, an auctioneer's telephone set 50 and an auctioneer voice manager 18.

In operation, bidders participate, in real-time, in an auction using bidder telephone sets 10 connected to the auction system 1. Each bidder telephone set 10 may establish a connection 16 through a telephony network 2, such as the Public Switch Telephony Network (PSTN), to a corresponding bid interpreter 14. The bid interpreters 14 process voice or DTMF bidder messages received through connections 16 from bidder telephone sets 10 into data packets. The data packets thus formed are passed through connections 24 and data network 3, such as the Internet, to be summarized and displayed on the auctioneer's computer 45, in a summary form. The auctioneer analyzes the information on the auctioneer computer 45 and uses the auctioneer telephone set 50 to enter a voice message to be broadcasted to the bidder telephone sets 10 of the participating bidders. The auctioneer's telephone set 50 establishes a connection 17 through the telephony network 2 to an auctioneer voice manager 18. The auctioneer voice manager 18 passes the auctioneer's voice through connections 26 to bid interpreters 14. In turn, the bid interpreters 14 pass the auctioneer messages through the connections 16 to bidder telephone sets 10. In this embodiment, the selection of the bidder telephone sets 10 corresponding to participating bidders, and which, therefore, should receive auctioneer messages, is done at the level of the bid interpreters 14, as it will be explained in more detail later.

The bid interpreters 14 are microcomputers performing various operations. One such operation is processing bidder messages into data packets to be sent to the auctioneer computer 45 for display or for further processing. Each data packet formed at a bid interpreter 14 and sent to the auctioneer computer 45, carries information identifying the bidder that entered the message or the corresponding bidder telephone set 10. For processing bidder voice messages into data packets, the bid interpreters 14 use suitable voice recognition algorithms known in the art. According to this embodiment, the bid interpreters 14 may also interpret DTMF signals received from bidder telephone sets 10 that have the touch-tone™ option.

Optionally, the bid interpreters 14 in FIG. 3 also perform various authorization procedures. Authorization procedures comprise requesting access information and analyzing access messages from bidders in order to verify the identities of bidders, their creditworthiness, their compliance with predetermined terms and conditions of the auction and the like. In order to perform the authorization procedures, the bid interpreters 14 use voice recognition and other decoding algorithms to recognize passwords or other access messages such as a credit card number. In this embodiment, the bid interpreters 14 may access credit databases in order to verify the credit information provided by bidders. Data packets informing the auctioneer computer 45 of the results of the authorization procedures carried at the bid interpreters 14 are sent through connections 24 to the auctioneer computer 45. Upon failure to meet authorization conditions, the auctioneer's computer 45 may deny participation in the auction to unauthorized bidders, by sending back data packets through connections 24 to the corresponding bid interpreters 14, commanding them to shut down. Alternatively, the auctioneer computer 45 may disconnect the input ports for connections 26 to the bid interpreters 14 corresponding to unauthorized bidders. Also, the auctioneer computer 45 may ignore the data packets coming through connections 24 from the bid interpreters 14 corresponding to unauthorized bidders.

The auctioneer computer 45 analyzes the data packets received from the bid interpreters 14. Selected data packets, such as those that contain bidding information, are outputted in a format that allows the auctioneer to acknowledge the content of the data packets and to identify the associated bidders. The data packets can be outputted by any means known in the art, such as visual, using a monitor terminal connected to the auctioneer computer 45 or audio, using speakers attached to the auctioneer computer 45. The auctioneer may select the output means and a format of outputting data packets best suited to his or her needs, by means of a user interface (not shown) on the auctioneer computer 45.

The data packets are presented according to a predetermined scheme. According to this embodiment, the auctioneer's computer 45 uses estimates of the different time delays for different bidders through networks 2 and 3 to compensate for the bias in favor of “closer” users, and uses these estimates in the predetermined scheme, in order to output data packets according to the time when the associated bidder messages were actually entered. In this embodiment, the auctioneer computer 45 accomplishes the time compensation routine by subtracting the round-trip delay through networks 2 and 3 of each data packet it receives, from the time at which same data packet is received, before deciding which data packet came first. The same method may be used to alert the auctioneer that a bidder had entered a bid before being able to hear the closing gavel, and the bid should therefore be allowed. The round-trip time estimates needed for this embodiment are obtained from the controlling software for the networks 2 and 3. Alternatively, the round-trip estimates could be obtained from the delay in receiving an echo from a bidder telephone set 10 using a system identification algorithm based on the echo cancellation technique known in the art.

In accordance with the embodiment in FIG. 3, the auctioneer computer 45 may command the bid interpreters 14 to act as part of a voice conferencing system by sending data packets through connections 24 to the bid interpreters 14. With the voice conferencing system thus enabled, bidders participating in the auction can hear the voices of active bidders in addition to the voice of the auctioneer. Active bidders are herein defined as bidders participating in the auction and entering bidder messages representing valid bids through their telephone sets 10. Inactive bidders are bidders participating in the auction that remain silent on the line, bidders involved in a different auction process than a bidding process, such a process of obtaining authorization, or bidders who make comments that do not pertain to the auction. The distinction among active and inactive bidders is made at the level of bid interpreters 14, which use voice recognition or other suitable decoding algorithms, to recognize the content of the messages received from bidders.

In accordance with another embodiment of the invention, an auction may be conducted with bidders participating in the auction over a communications network using voice terminals connected to an auction system such as described in any of FIGS. 1 to 3, for example, with other bidders being physically present to the auction, and yet with other bidders participating in the auction over the Internet.

The invention could also be implemented to a lesser extent on existing Internet and PSTN networks. For example, Internet servers could be given much of the functionality of the invention similar to applications such as NetMeeting. Alternatively, the invention could be implemented as an application program on the personal computers of end users interconnected over the Internet, although this allows the possibility of timestamps being inaccurate or falsified, and also makes it difficult to ensure that all participants are using current software. On the PSTN a specialized server could be attached to a class 5 switch. These implementations would not have all the benefits of the invention, but could apply certain aspects of its teachings.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

Numerous modifications, variations, and adaptations may be made to the particular embodiments of the invention described above, without departing from the scope of the invention.

What is claimed is:

1. A bidder message processor comprising:
processing means for processing a bidder message entered through a bidder voice terminal into a bidder data signal, wherein said bidder data signal includes a bidder identifier; and
output means for outputting the bidder data signals at an auctioneer terminal.

2. The bidder message processor in claim 1, wherein the processing means further comprises means for recognizing an auction relevant bidder message.

3. The bidder message processor in claim 2, wherein the means for recognizing comprises means for decoding a Dual Tone Multi Frequency (DTMF) bidder message.

4. The bidder message processor in claim 2, wherein the means for recognizing comprises voice recognition means for decoding a voice bidder message.

5. The bidder message processor in any one of claims 3 or 4, wherein the means for recognizing further comprises means for identifying each detected auction relevant messages as being either one of a bid and an access messages.

6. The bidder message processor in claim 1, further comprising access control means for determining a right of access of a bidder to an auction.

7. The bidder message processor in claim 6, further comprising:
means for generating an access information request and transmitting the same to said bidder voice terminal.

8. The bidder message processor in claim 5, wherein the access message can be any one of a password, a credit information code, a response of compliance with predetermined access terms and conditions for the auction.

9. The bidder message processor in claim 5, wherein said access control means further comprises means for verifying the access messages.

10. The bidder message processor system in claim 9, wherein said means for verifying comprises means to connect to a database of access information.

11. A bidder message processor system comprising
a bidder message processor as in claim 1; and
connecting means for connecting said bidder message processor to said bidder voice terminal over a communications network.

12. The bidder message processor system in claim 11, wherein the bidder message processor further comprises access control means for determining a right of access of a bidder to an auction, and wherein the access control means generates access control signals for allowing said connecting means to connect the bidder voice terminal to the auctioneer terminal and for creating a record of participating bidders.

13. The bidder message processor system in claim 11, wherein said connecting means comprises connections through a Public Switch Telephony Network (PSTN).

14. The bidder message processor system in claim 11, wherein the connecting means is coupled to a voice conferencing means, for allowing the bidder voice terminal to voice conference with other bidder voice terminals connected to said auctioneer terminal through said connecting means.

15. The bidder message processor system in claim 14, wherein the connecting means is coupled to time compensation control means, for accounting for the propagation delay of said bidder message in travelling through the connecting means.

16. An auctioneer message processor system comprising:
an auctioneer voice transmitter for broadcasting auctioneer voice messages from an auctioneer terminal simultaneously to a plurality of bidder voice terminals; and
connecting means for connecting said bidder voice terminals to said auctioneer voice transmitter over a communications network.

17. An auctioneer message processor in claim 16, wherein a record of participating bidders is updated through said connecting means and said auctioneer voice transmitter broadcasts auctioneer voice messages only to bidder voice terminals selected according to said record of participating bidders.

18. An auction system for use in an auction conducted over a communications network, the auction system comprising:
a bidder message processor comprising:
means for processing a bidder message entered through any one of a plurality of bidder voice terminals into a bidder data signals, wherein said bidder data signal comprises a bidder identifier; and
means for outputting the bidder data signals at an auctioneer terminal;
an auctioneer voice transmitter for broadcasting auctioneer voice messages from the auctioneer terminal simultaneously to selected bidder voice terminals; and
connecting means for connecting said bidder voice terminals to the bidder message processor and to the auctioneer voice transmitter over the communications network.

19. An auction system comprising:
auctioneer output means;
a plurality of bid interpreters which in operation are connected to a plurality of corresponding bidders voice terminals, wherein each bid interpreter comprises:
means for decoding bidder messages;
means for attaching corresponding bidder identifiers to each decoded bidder message and forming data signals; and
means for transmitting the data signals to the auctioneer output means, over a communications network,
an auctioneer voice manager coupled to the bid interpreters, for receiving voice messages from an auctioneer voice transmitter over the communications network and for broadcasting the auctioneer voice messages simultaneously to all bidder voice terminals connected to the bidder interpreters.

20. A method of processing bidder messages for use in an auction conducted over a communications network, the method comprising the steps of:
processing a bidder messages received entered through a voice terminal into a data (digital) signals;
attaching a bidder identifier to said data signal; and
outputting said data signal at an auctioneer terminal.

21. A method of conducting an auction over a communications network, the method comprising the steps of:
transmitting bidders messages over the communications network by:
receiving the bidder messages from a plurality of bidder voice terminals;
processing bidders messages into data signals;
forming output signals by attaching bidder identifiers to selected data signals; and
sending and outputting the output signals at an auctioneer terminal; and
transmitting auctioneer messages over the communications network by:
receiving the auctioneer messages from the auctioneer terminal;
broadcasting the auctioneer messages to selected bidder voice terminals.

22. A computer data signal embodied in a carrier wave, said computer data signal comprising a set of machine executable code being executable by a computer to perform the steps of any one of claims 20 or 21.

23. A computer readable storage medium storing a set of machine executable code, said set of machine executable code being executable by a computer server to perform the steps of any one of claims 20 or 21.
